(19) United States
(12) Patent Application Publication
(10) Pub. No.: US 2013/0315555 A1
(43) Pub. Date: Nov. 28, 2013

(54) IMAGE PROCESSING APPARATUS AND METHOD FOR VEHICLE

(71) Applicant: CORE LOGIC INC., Seoul (KR)

(72) Inventor: Min-Sik SHIM, Seoul (KR)

(73) Assignee: CORE LOGIC INC., Seoul (KR)

(21) Appl. No.: 13/900,068

(22) Filed: May 22, 2013

(30) Foreign Application Priority Data
May 23, 2012 (KR) 10-2012-0054938

(51) Int. Cl. H04N 9/797

(52) U.S. Cl. CPC H04N 9/797
USPC 386/223

(57) ABSTRACT

Disclosed herein is an image processing apparatus for vehicles which, when image input sources correspond to two or more image input channels, includes a plurality of central processors for image control of the channels, respectively, wherein a master central processor for controlling the other central processors is selected from among the plurality of central processors and images of the channels are stored as one file under control of the master central processor, thereby enhancing video recording quality and simplifying storage and recording of the videos. An image processing method for vehicles is also disclosed herein.

### CROSS-REFERENCE TO RELATED APPLICATION

This application claims priority to Korean Patent Application No. 10-2012-0054938 filed on 23 May, 2012, and all the benefits accruing therefrom under 35 U.S.C. §119, the contents of which is incorporated by reference in its entirety.

### BACKGROUND

1. Technical Field

The present invention relates to image processing apparatus and method for vehicles, and more particularly, to an image processing apparatus for vehicles wherein an image input source includes two or more image input channels, and an image processing method for vehicles.

In more detail, the present invention relates to an image processing apparatus for vehicles which, when image input sources correspond to two or more image input channels, that is, a plurality of cameras, includes a plurality of central processors for individual image control of the cameras, wherein a master central processor for controlling the other central processors is selected from among the plurality of central processors and images of the cameras are stored as one file under control of the master central processor, thereby enhancing video recording quality and simplifying storage and recording of the videos, and to an image processing method for vehicles.

In addition, the present invention relates to an image processing apparatus for vehicles, which, when image input sources correspond to two or more image input channels, that is, a plurality of cameras, allows images of the cameras to be selectively stored in a single file or individual files, and to an image processing method for vehicles.

For reference, the term “image processing” as used herein corresponds to a concept including video recording and storage.

2. Description of the Related Art

As generally known in the art, a black box for vehicles photographs an accident situation using small cameras disposed on front and rear windshields of the vehicle, and collects and stores audio data collected by a microphone in a storage medium, for example, a memory card. The black box normally records situations relating to driving of the vehicle for durations secured by the storage medium. The black box is operated as soon as the vehicle is started, and in the case of an accident, that is, if impact is applied to the vehicle, driver's voice, impact sounds, operating situations of an accelerator, a vehicle speed, a time point, and the like are recorded in the storage medium in detail.

FIG. 1 is a block diagram of a black box system for vehicles in the related art.

Referring to FIG. 1, the black box system includes sensors 14, 16 for detecting a vehicle speed, external impact, and the like, a front camera 10 for photographing a forward side of the vehicle, a rear camera 12 for photographing a rearward side of the vehicle, and a black box 18 which stores vehicle driving information.

The black box 18 includes video encoder 20, video sensor 22 and video decoder 24 which control input and output of video signals by the front and rear cameras 11, 12 and decode or encode the input and output video signals; a microcomputer 28 which controls overall operation of the black box 18; a drive data memory 30 which stores driving situations captured by the front and rear cameras as video signals for a predetermined period of time set based on a current time by a timer 34; and a video memory 26 which decompresses current video signals recorded in a compressed state in the drive data memory 30 and stores the decompressed video signals.

Further, the black box 18 includes a display unit 44 for displaying video signals stored in the drive data memory 30 and the video memory 26, and an input interface unit 32 for inputting signals of the speed sensor 14 and the impact sensor 16, the vehicle mechanism input signal and the key detection signal to the microcomputer 28.

Normally, the drive data memory 30 repeatedly performs an operation of storing and removing driving conditions of the vehicle at predetermined intervals, and stores a driving condition before and after an accident according to a signal from an impact sensor when the accident occurs.

In such a box system for vehicles, video recording is generally performed by a one-channel video recording type or a two-channel video recording type.

The two channel video recording type is largely classified into a configuration employing one central processor (CPU), as shown in FIG. 2 and a configuration employing two central processors CPU1, CPU2 responsible for respective channels, as shown in FIG. 3.

In the configuration of FIG. 2, a plurality of image input sources, that is, Camera 1 and Camera 2, select input images and store the input images in a image file storage unit under preset conditions. For example, if an image processor can encode 30 frames per second (fps), images of the first channel camera may be encoded in an encoder at 15 fps and recorded in the image file storage unit, and images of the second channel camera may be encoded at 15 fps and recorded in the image file storage unit. Here, the images of the first channel camera may be encoded at 20 fps and recorded in the image file storage unit, and the images of the second channel camera may be encoded at 10 fps and recorded in the image file storage unit.

FIG. 3 shows a structure having independent configurations for image processing for the respective channel cameras. That is, in the configuration of FIG. 3, if the number of cameras is two, two central processors, two interfaces, two encoders and two image file storage units are respectively provided.

However, in the aforementioned related art, the configuration of FIG. 2 has a problem in that video recording quality deteriorates because input images are selected from the plurality of image input sources, and the configuration of FIG. 3 has a problem in that, although video recording quality can be secured due to the independent configurations of the channels, the image files must be separately stored, thereby causing cost increase.

### BRIEF SUMMARY

An aspect of the present invention is to provide an image processing apparatus for vehicles which, when image input sources correspond to two or more image input channels, includes a plurality of central processors for image control of the channels, respectively, wherein a master central processor for controlling the other central processors is selected from the plurality of central processors and images of the channels are stored as one file under control of the master central processor, thereby enhancing video recording quality and simplifying storage and recording of the videos, and an image processing method for vehicles.

Another aspect of the present invention is to provide an image processing apparatus for vehicles which, when image input sources correspond to two or more image input channels, that is, a plurality of cameras, allows images of the cameras to be selectively stored in a single file or individual files, and an image processing method for vehicles.

In accordance with one aspect of the invention, an image processing apparatus for vehicles, which processes images input from a plurality of cameras, includes: a first image processing unit which processes an image input from one camera among the plurality of cameras; a second image processing unit which processes an image input from another camera among the plurality of cameras under control of the first image processing unit and outputs the processed image to the first image processing unit; and an image file storage unit which stores the images processed by the first image processing unit and the second image processing unit under control of the first image processing unit.

The first image processing unit may be a master image processor, and the second image processing unit may be a slave image processor, and each of the first and the second image processing units may include: an encoder which encodes an input image and a central processor for controlling the encoder.

The first image processing unit may include: a buffer which temporarily stores the images encoded by the encoders before the encoded images are stored in the image file storage unit; and a storage type selector which selects a storage type of the image files stored in the buffer. Here, the image file storage unit stores the image files as a single file or a plurality of separate files according to the storage type selected by the storage type selector.

The central processor of the first image processing unit may control the central processor of the second image processing unit as the master central processor.

The image encoded by the encoder of the first image processing unit may be directly sent to the buffer, and the image encoded by the encoder of the second image processing unit may be sent to the buffer via at least one of a serial peripheral interface (SPI), USB, SDIO, and SCI.

The first image processing unit may control the second image processing unit through at least one communication protocol selected from among Universal Asynchronous Receiver/Transmitter (UART), General Purpose Input/Output (GPIO), and I-square-C (I2C).

In accordance with another aspect of the invention, an image processing method for vehicles, in which an image processing apparatus for vehicles processes images input from a plurality of cameras, includes: processing an image input from one of the plurality of cameras by a first image processing unit; processing an image input from another camera of the plurality of cameras by a second image processing unit under control of the first image processing unit; and storing the images processed by the first image processing unit and the second image processing unit in an image file storage unit under control of the first image processing unit, wherein the image processed by the second image processing unit is stored in the image file storage unit through the first image processing unit.

Only the first image processing unit may perform image recording when only image recording by the first image processing unit is selected.

The second image processing unit may not perform image recording when only image recording by the first image processing unit is selected.

The respective images processed by the first and second image processing unit may be selectively stored as a single file or a plurality of separate files in the image file storage unit.

### BRIEF DESCRIPTION OF THE DRAWINGS

The above and other aspects, features, and advantages of the present invention will become apparent from the detailed description of the following embodiments in conjunction with the accompanying drawings, in which:

FIG. 1 is a block diagram of a black box system for vehicles in the art;

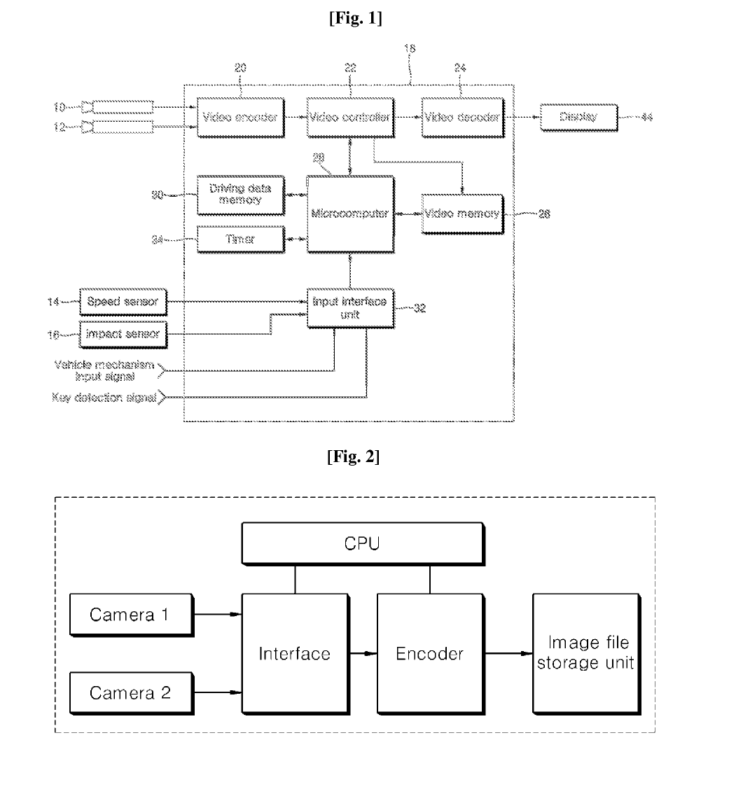

FIG. 2 is a block diagram of one example of an image processing apparatus for vehicles in the art;

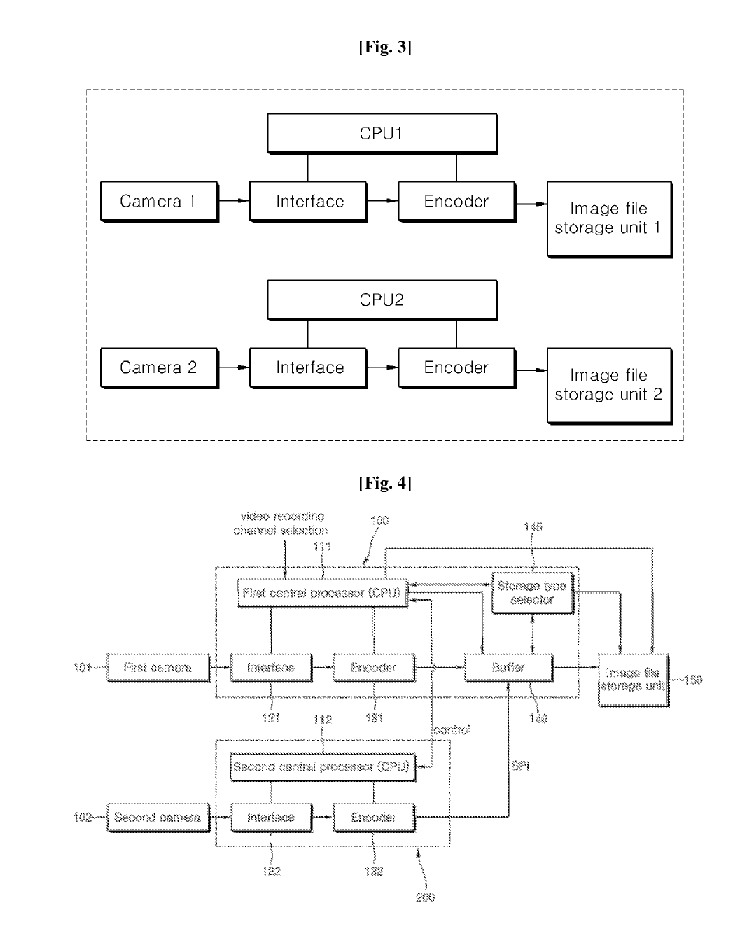

FIG. 3 is a block diagram of another example of an image processing apparatus for vehicles in the art;

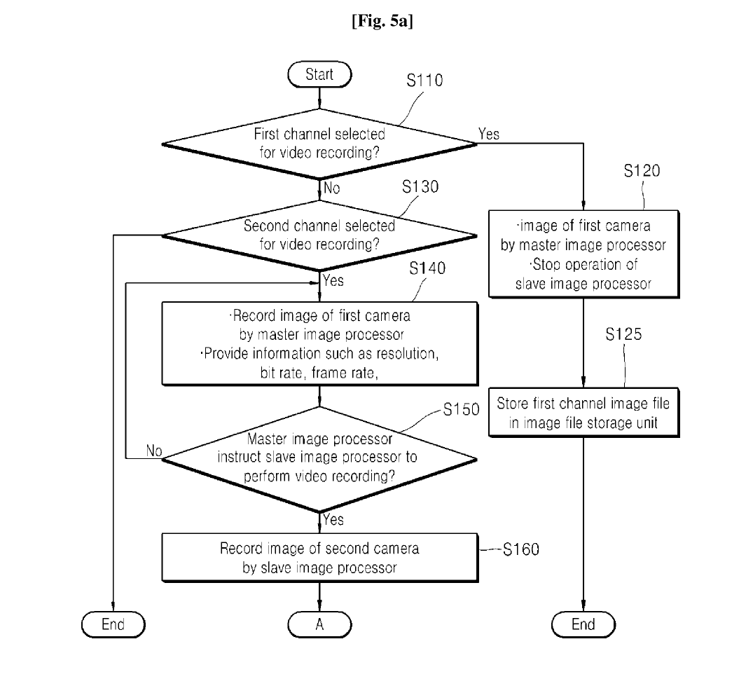

FIG. 4 is a block diagram of an image processing apparatus for vehicles according to one embodiment of the present invention; and

FIGS. 5a to 5c are flowcharts of an image processing method for vehicles according to one embodiment of the present invention.

### DETAILED DESCRIPTION

Exemplary embodiments of the present invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. Descriptions of details apparent to those skilled in the art will be omitted for clarity of description. The same components will be denoted by the same reference numerals throughout the specification.

As used herein, the term “image processing” corresponds to a concept including video recording and storage.

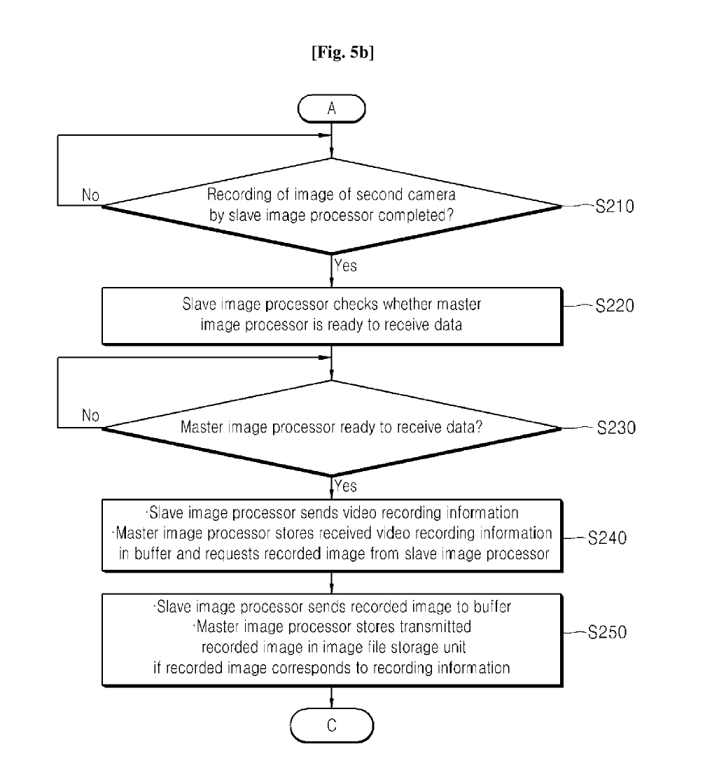

FIG. 4 is a block diagram of an image processing apparatus for vehicles according to one embodiment of the present invention. Although two cameras 101, 102 are shown in FIG. 4, it should be understood that the present invention is not limited thereto.

Referring to FIG. 4, an image processing apparatus for vehicles according to one embodiment may include a plurality of cameras 101, 102 and a plurality of image processors 100, 200, which process images output from the plurality of cameras 101, 102, respectively.

The plurality of cameras 101, 102 may include a first camera 101 and a second camera 102. The first camera 101 may photograph an image of a forward direction of the vehicle, for example, a front side of the vehicle, and the second camera 102 may photograph an image of a rear side of the vehicle.

The plurality of image processors 100, 200 may include a first image processing unit 100 which may process the image of the first camera 101, and a second image processing unit 200 which may process the image of the second camera 102.

In this case, the first image processing unit 100 may operate as a master image processor, and the second image processing unit 200 may operate as a slave image processor whose operation is controlled by the first image processing unit 100.

The first image processing unit 100 may be set to operate as the master image processor when the image processing apparatus for vehicles is driven (or when a vehicle is started). Of course, the first image processing unit 100 may be set to operate as the master image processor by user selection.

Hereinafter, for convenience of description, the first image processing unit 100 will be referred to as the master image processor and the second image processing unit 200 will be referred to as the slave image processor.

The master image processor 100 and the slave image processor 200 may include encoders 131, 132 for encoding camera images, and central processors (CPU) 111, 112 for controlling the encoders 131, 132, respectively.

The master image processor 100 includes a first central processor 111 which acts as a master central processor, and the slave image processor 200 includes a second central processor 112 which acts as a slave central processor.

The master image processor 100 may include a buffer 140 which temporarily stores images encoded by the encoder 131, 132 before the encoded images are stored in an image file storage unit 150, and a storage type selector 145 which selects a storage type of the image files stored in the buffer 140.

The image file storage unit 150 may store image files as a single file or a plurality of separate files according to the storage type selected by a user through the storage type selector 145 or according to the storage type set as default.

An image captured by the first camera 101 is sent to the encoder 131 via an interface 121. The process of sending the image captured by the first camera 101 to the encoder 131 may be one well-known in the art.

Transmission of the image captured by the first camera 101 to the encoder 131 via the interface 121 may be controlled by the first central processor (CPU) 111.

The encoder 131 may encode the image sent under control of the first central processor 111.

The buffer 140 connected to a rear end of the encoder 131 may temporarily store the image encoded by the encoder 131 under control of the first central processor 111.

The image file storage unit 150 may store image data stored in the buffer 140 as an image file. The image file storage unit 150 may be controlled by the first central processor 111.

When two or more cameras are used, the image file storage unit 150 may store the images of the cameras as separate files corresponding to the cameras or as a single file according to selection of the storage type. When the images of the cameras are stored as a single file, an audio video interleaved (AVI) format may be preferably used.

The image captured by the second camera 102 is sent to the encoder 132 through the interface 122 under control of the second central processor 112. The encoder 132 may encode the image captured by the second camera 102 under control of the second central processor 112.

The second central processor 112 operates only in response to a control signal for instructing operation of the first central processor 111. As described above, the first central processor 111 may operate as the master central processor. Accordingly, the first central processor 111 may output an operation instruction signal to the second central processor 112, and the second central processor 112 may control the encoder 132 to encode the image captured by the second camera 102 in response to the operation instruction signal.

The image encoded by the encoder 132 may be sent to the buffer 140 of the master image processor 100 as the first central processor 111 controls the second processor 112.

When the first central processor 111 does not send the operation instruction signal to the second central processor 112, the second central processor 112 does not operate, and the image of the second camera 102 is not encoded by the encoder 132.

For example, the operation instruction signal may be intermittently output from the first central processor 111 according to a preset time.

The first central processor 111 sends the operation instruction signal to the second central processor 112 through a communication protocol, such as Universal Asynchronous Receiver/Transmitter (UART), General Purpose Input/Output (GPIO) or I-square-C (I2C).

Although the image of the second camera 102 encoded by the encoder 132 may be sent to the buffer 140 through a Serial Peripheral Interface (SPI) under control of the second central processor 112 controlled by the first central processor 111, the present invention is not limited thereto.

That is, the image of the second camera 102 encoded by the encoder 132 may be sent to the buffer 140 through at least one of Universal Serial Bus (USB), Secure Digital Input Output (SDIO), and Scalable Coherent Interface (SCI) in addition to the Serial Peripheral Interface (SPI) under control of the second central processor 112 controlled by the first central processor 111.

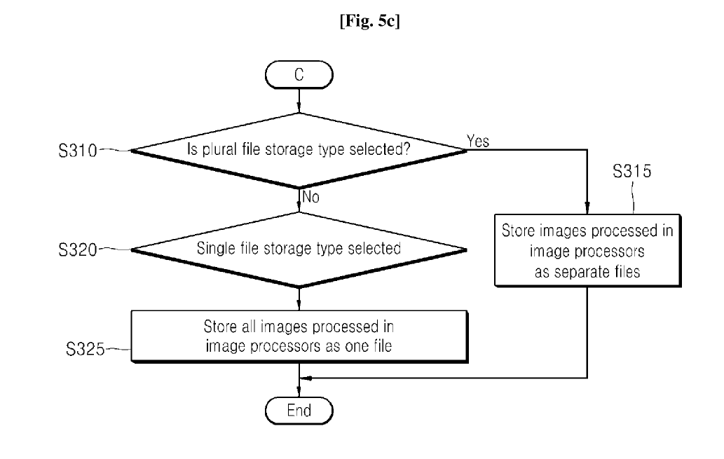

Next, an image processing method for vehicles according to one embodiment of the present invention will be described with reference to FIGS. 5a to 5c.

FIG. 5a is a flowchart of a process of determining whether an image processing type is a one channel type or a two channel type (or a plurality of channels), and processing an image.

FIG. 5b is a flowchart of a process of sending an image from a slave image processor 200 to a master image processor 100.

FIG. 5c is a flowchart of a process of storing a file in an image file storage unit 150.

A user determines whether video recording is performed with one channel or two channels (S110) (S130). For example, a user may select the number of recording channels through a video recording channel selection button disposed on in the storage type selector 145 of the black box system for vehicles.

When a user selects one channel video recording, the first central processor 111 of the master image processor 100 may control one channel video recording. Operation of the slave image processor 200 may be stopped or enter standby under control of the master image processor 100 (S120). The stop or standby of the slave image processor 200 may be determined in accordance with design.

In other words, the first central processor 111 of the master image processor 100 may send a signal for stopping or waiting for the operation of the second central processor 112 of the slave image processor 200 to the second central processor 112, and may allow only an image of the first camera 101 to be encoded by the encoder 131 of the master image processor 100.

An image file processed by the master image processor 100 may be stored in the image file storage unit 150 (S125). That is, the image encoded by the encoder 131 of the master image processor 100 is stored in the buffer 140, and then is stored in the image file storage unit 250 of the first central processor 111 as a video recording image file (S125).

When a user selects two channel video recording, the first central processor 111 of the master image processor 100 processes the image of the first camera 101 as in the aforementioned one channel video recording, and provides information, such as resolution, bit rate, frame rate, and codec which are necessary for processing of the image of the second camera 102, to the central processor 112 of the slave image processor 200.

In two channel video recording, the first camera 101 and the second camera 102 may simultaneously perform photographing operation. That is, the first camera 101 and the second camera 102 may start to perform photographing operation at the same time in response to a control signal of the one channel.

The second central processor 102 of the slave image processor 200 receives information for processing of the image of the second camera 102 which is sent from the first central processor 111 of the master image processor 100, and waits for the image processing instruction signal of the first central processor 111 (S150).

That is, the second central processor 112 receives information for image processing and then, for example, sends a signal of “Information completely received” to the first central processor 111. Then, the first central processor 111 receives the signal and sends an image processing start signal to the second central processor 112 if the signal is determined as “Information completely transmitted.”

Namely, since sent information can be lost during communication, that is, during exchange of signals between the first and the second central processors 111, 112, the operation of sending information again is needed in the event where desired image information fails to be properly received.

When the first central processor 111 of the master image processor 100 sends the image processing instruction signal to the second central processor 112 of the slave image processor 100, the second central processor 112 controls the interface 122 and the encoder 132 to process the image of the second camera 102 (S160).

That is, the encoder 132 of the slave image processor 200 encodes the image of the second camera 102 applied through the interface 122 under control of the second central processor 112.

As described above, when processing the image of the second camera 102 is completed under control of the second central processor 112 (S210), the second central processor 112 sends a signal for completing the image processing of the second camera 102 to the first central processor 111.

In detail, when the first central processor 111 receives the signal for completing image processing of the second camera 102 from the second central processor 112, the slave image processor 200 checks whether the master image processor 100 is ready to receive data (S220). Further, it is checked whether the master image processor 100 is ready to receive data (S230).

Upon receiving a signal permitting transmission of the video recording image from the first central processor 111, the second central processor 112 sends image processing related information, for example, frame information to the first central processor 111.

Upon receiving the image processing related information transmitted from the second central processor 112, the first central processor 111 stores the image processing related information and instructs transmission of the processed image of the second camera 102 (S240).

Upon receiving the instruction for transmission of the image of the second camera 102, the second central processor 112 sends the processed image of the second camera 102 to the buffer 104 (S250).

When the processed image of the second camera 102 is transmitted to the buffer 140, the first central processor 111 checks whether the previously transmitted image processing information corresponds to the image of the second camera 102, and if yes, stores the image of the first camera 101 and the image of the second camera 102 in the image file storage unit 150 according to a selected file storage type.

As shown in FIG. 4, a user may select the file storage type through the storage type selector 145 as described above. For example, the storage type selector 145 may be installed on a control panel of the black box system to which the present invention may be applied.

That is, when a separate plural file storage type is selected as a file storage type, the first central processor 111 stores images photographed and processed by the cameras 101, 102 in the image file storage unit 150 as separate files. (S310) (S315).

When a single file storage type is selected as a file storage type, the first central processor 111 stores the images encoded by the master image processor 100 and the slave image processor 200 in the image file storage unit 150 as one single file (S320) (S325). At this time, the single file may correspond to an audio video interleaved (AVI) file format, but the present invention is not limited thereto.

Obviously, the image processing method for vehicles according to the above embodiment may be performed in an automated procedure according to time-based order by a software program embedded in a storage medium. Codes or code segments organizing the program may be easily deduced by computer programmers in the art. Moreover, the program is stored in computer readable media, and is read and executed by a computer, thereby realizing the method. The computer readable media may include magnetic recording media, optical recording media, and carrier wave media.

As such, in the image processing method and apparatus according to the present invention, when image input sources correspond to two or more image input channels, that is, a plurality of cameras, a master image processor for controlling the other image processors is selected from a plurality of image processors which processes images of the channels, and the images of the channels are recorded and stored in individual files or a single file under control of the master image processor, thereby improving image recording quality and simplifying storage of the images.

Although some exemplary embodiments have been described herein, it should be understood by those skilled in the art that these embodiments are given by way of illustration only, and that various modifications, variations and alterations can be made without departing from the spirit and scope of the invention. The scope of the present invention should be defined by the appended claims and equivalents thereof.

What is claimed is:

1. An image processing apparatus for vehicles which processes images input from a plurality of cameras, comprising:
a first image processing unit which processes an image input from one camera of the plurality of cameras;
a second image processing unit which processes an image input from another camera of the plurality of cameras under control of the first image processing unit and outputs the processed image to the first image processing unit; and
an image file storage unit which stores the images processed by the first image processing unit and the second image processing unit under control of the first image processing unit.

2. The image processing apparatus according to claim 1, wherein the first image processing unit is a master image processor, the second image processing unit is a slave image processor, and each of the first and the second image processing units comprises an encoder for encoding an input image, and a central processor for controlling the encoder.

3. The image processing apparatus according to claim 2, wherein the first image processing unit comprises a buffer which temporarily stores the images encoded by the encoders before the encoded images are stored in the image file storage unit, and a storage type selector which selects a storage type of the image files stored in the buffer, the image file storage unit storing the image files as a single file or a plurality of separate files according to the storage type selected by the storage type selector.

4. The image processing apparatus according to claim 3, wherein the central processor of the first image processing unit controls the central processor of the second image processing unit as the master central processor.

5. The image processing apparatus according to claim 4, wherein operation of the second image processing unit is stopped when only processing by the first image processing unit is selected, and the operation of the second image processing unit is performed under control of the first image processing unit when two channel processing by the first image processing unit and the second image processing unit is selected.

6. An image processing method for vehicles, in which an image processing apparatus for vehicles processes images input from a plurality of cameras, the method comprising:
processing an image input from one of the plurality of cameras by a first image processing unit;
processing an image input from another camera of the plurality of cameras by a second image processing unit under control of the first image processing unit; and
storing the images processed by the first image processing unit and the second image processing unit in an image file storage unit under control of the first image processing unit,
wherein the image processed by the second image processing unit is stored in the image file storage unit through the first image processing unit.

7. The image processing method according to claim 6, further comprising:
selecting one from among one channel processing and two channel processing by a user; and
stopping operation of the second image processing unit by the first image processing unit when one channel processing is selected.

8. The image processing method according to claim 6, further comprising:
selecting one from among one channel processing and two channel processing by a user,
when two channel image processing is selected, the method further comprising:
sending an operation instruction signal to the second image processing unit by the first image processing unit; and
processing the image input from the other camera by the second image processing unit in response to the operation instruction signal,
wherein the first image processing unit and the second image processing unit simultaneously operate.

9. The image processing method according to claim 8, further comprising, before sending an operation instruction signal:
sending image processing information to the second image processing unit by the first image processing unit; and
sending an image processing information reception completion signal to the first image processing unit by the second image processing unit.

10. The image processing method according to claim 8, wherein the storing the images in the image file storage unit comprises:
sending an image processing completion signal and image processing information to the first image processing unit by the second image processing unit;
sending an image sending instruction to the second image processing unit by the first image processing unit; and
comparing the image processing information with a processed image by the first image processing unit after the second image processing unit sends the processed image to the first image processing unit in response to the image sending instruction.

11. The image processing method according to claim 8, wherein the storing the images in the image file storage unit comprises selecting one of a single file storage type and a separate file storage type,
wherein an image processed in the first image processing unit and an image processed in the second image processing unit are integrated into one image data file to be stored in the image file storage unit under control of the first image processing unit when the single file storage type is selected, and
wherein an image processed in the first image processing unit and an image processed in the second image processing unit are stored in the image file storage unit as separate image data files under control of the first image processing unit when the separate file storage type is selected.
